(19) United States
(12) Patent Application Publication
(10) Pub. No.: US 2011/0195389 A1
(43) Pub. Date: Aug. 11, 2011

(54) SYSTEM AND METHOD FOR TRACKING PROGRESSION THROUGH AN EDUCATIONAL CURRICULUM

(75) Inventors: Dennis C. DeYoung, Webster, NY (US); Manokar Velayutham, Tamailnadu (IN); Maurice Biche, Pondicherry (IN)

(73) Assignee: Xerox Corporation, Norwalk, CT (US)

(21) Appl. No.: 12/701,850

(22) Filed: Feb. 8, 2010

(51) Int. Cl. G09B 7/00

(52) U.S. Cl. 434/350; 434/362

(57) ABSTRACT

A processing system and a method are provided for tracking progress through a curriculum having a plurality of topics by analyzing at least one digital assessment. Each digital assessment was administered to an assessment-taker and has at least one problem that assesses the assessment-taker's understanding of at least one of the topics. The system includes at least one tangible processor and a memory with instructions to be executed by the at least one tangible processor for processing the at least one digital assessment and determining which topics of the curriculum have been taught based on which topics are associated with the respective problems included in the at least one processed digital assessment. Furthermore, the instructions may be executed by the at least one tangible processor for accessing and comparing the results of determinations for a first and second groups of assessment-takers of which topics of the curriculum have been taught.

### CROSS-REFERENCE TO RELATED APPLICATIONS

The present application is related to: U.S. patent application Ser. No. 12/339,979 to German et al., entitled “SYSTEM AND METHOD FOR RECOMMENDING EDUCATIONAL RESOURCES,” filed on Dec. 19, 2008; U.S. patent application Ser. No. 12/340,054 to German et al., entitled “SYSTEM AND METHOD FOR RECOMMENDING EDUCATIONAL RESOURCES,” filed on Dec. 19, 2008; U.S. patent application Ser. No. 12/340,116 to German et al., entitled “SYSTEM AND METHOD FOR RECOMMENDING EDUCATIONAL RESOURCES,” filed on Dec. 19, 2008; U.S. patent application Ser. No. 12/237,692 to DeYoung, entitled “AUTOMATIC EDUCATIONAL ASSESSMENT SERVICE,” filed on Sep. 25, 2008; U.S. patent application Ser. No. 12/339,804 to DeYoung, entitled “AUTOMATIC EDUCATIONAL ASSESSMENT SERVICE,” filed on Dec. 19, 2008; U.S. patent application Ser. No. 12/339,771 to DeYoung, entitled “AUTOMATIC EDUCATIONAL ASSESSMENT SERVICE,” filed on Dec. 19, 2008; U.S. patent application Ser. No. 12/341,659 to Lofthus et al., entitled “SYSTEM FOR AUTHORING EDUCATIONAL ASSESSMENTS,” filed on Dec. 22, 2008, and U.S. patent application Ser. No. 12/640,426, all of which are incorporated herein by reference in their entirety.

### BACKGROUND

The present disclosure relates generally to a system and method for tracking progression through an educational curriculum. In particular, the present disclosure relates to providing information indicative of progression through an educational curriculum which enables an educator to pace his/her progress through a similar curriculum.

One of the more challenging aspects of teaching is pacing the instruction of subject matter to be taught in order complete a curriculum within a time frame, such as a school semester or school year. Pacing instruction is a skill that develops with experience. However, even for an experienced educator, challenges arise when the pace needs to be adjusted to account for variables, such as a change in curriculum, the composition of the student body, and unexpected events.

### SUMMARY

The present disclosure is directed to a processing system for tracking progress through a curriculum having a plurality of topics by analyzing at least one digital assessment. Each digital assessment was administered to an assessment-taker and has at least one problem that assesses the assessment-taker's understanding of at least one topic of the plurality of topics The system includes at least one tangible processor and a memory with instructions to be executed by the at least one tangible processor for processing the at least one digital assessment and determining which topics of the plurality of topics of the curriculum have been taught based at least partially on which topics are associated with the respective problems included in the at least one processed digital assessment.

The present disclosure is further directed to a computer-readable medium storing a series of programmable instructions configured for execution by at least one hardware processor for tracking progress through a curriculum having a plurality of topics by analyzing at least one digital assessment. Each digital assessment was administered to an assessment-taker and has at least one problem that assesses the assessment-taker's understanding of at least one topic of the plurality of topics. The instructions includes the steps of processing the at least one digital assessment and determining which topics of the plurality of topics of the curriculum have been taught based at least partially on which topics are associated with the respective problems included in the at least one processed digital assessment.

The present disclosure is additionally directed to an educational assessment system for tracking progress through a curriculum having a plurality of topics by analyzing at least one assessment. The system includes a tangible processor and a memory with instructions to be executed by the tangible processor for processing the digital assessments. Each digital assessment was administered to an assessment-taker and has problems that assess the assessment-taker's understanding of at least one topic of the plurality of topics. The memory instructions are further processed by the tangible processor for processing a digital assessment template which is associated with each digital assessment, and includes associated with each problem at least one of category information indicating the at least one topic assessed by the problem, and descriptor information associated with respective possible responses to the problem.

The descriptor information associated with each possible response indicates the assessment-taker's understanding of a particular topic of the at least one topic, wherein the descriptor information associated with two respective possible responses the problem indicate the assessment-taker's understanding of different respective particular topics. The memory instructions are further processed by the tangible processor for determining which topics of the plurality of topics of the curriculum have been taught based at least partially on at least one of the category and descriptor information associated with the respective problems included in the at least one processed digital assessment.

### BRIEF DESCRIPTION OF THE DRAWINGS

Various embodiments of the present disclosure will be described below with reference to the figures, wherein:

FIG. 1 is a schematic flow diagram of an educational assessment service (EAS) system in accordance with the present disclosure;

FIG. 2 is a block diagram of a second EAS workstation of the EAS system in accordance with the present disclosure;

FIG. 3 is a block diagram of an EAS evaluator of the EAS system in accordance with the present disclosure; and

FIG. 4 is a graph showing the concentration of EAS assessment problems over time for a variety of educational categories in accordance with the present disclosure.

### DETAILED DESCRIPTION

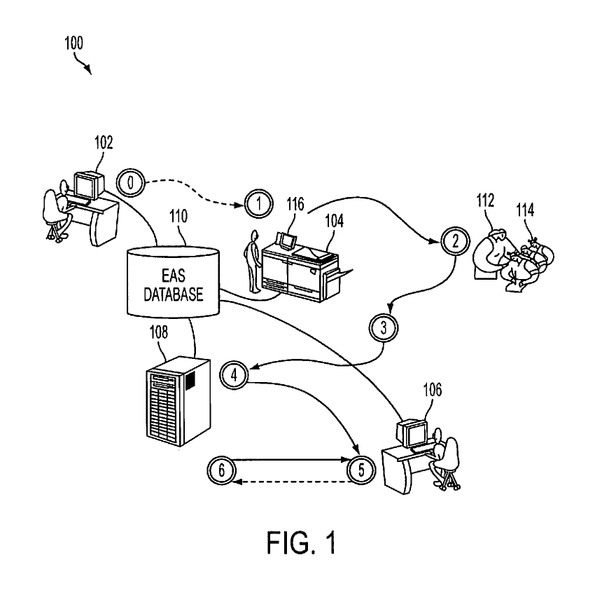

Referring now to the drawing figures, in which like references numerals identify identical or corresponding elements, the educational recommender system and method in accordance with the present disclosure will now be described in detail. With initial reference to FIG. 1, an exemplary educational assessment service (EAS) system in accordance with the present disclosure is illustrated and is designated generally as EAS system 100. Exemplary components of the EAS system 100 include a first EAS workstation 102, an EAS multi-functional device (MFD) 104, a second EAS workstation 106, an EAS evaluator 108, and an EAS database 110. An EAS assessment is generated at the first EAS workstation 102 and stored on the EAS database 110.

The EAS system 100 tracks the progress of an educator (e.g., teacher or professor) through a curriculum associated with a particular subject(s) (e.g., geometry, calculus, American History, European Literature), allowing the educator to pace and/or evaluate his progress through the curriculum or subject material. The term “curriculum” may refer to a formal curriculum (e.g., ascribed or mandated by a school district or state educational requirements), an informal curriculum (e.g., an educational program, plan of activities, or material to be taught, course of study, syllabus, etc., which may be generally known, traditional, and/or developed by one or more educators), a portion of a curriculum, or a collection of educational material related to a particular subject matter. The curriculum may include, e.g., be broken down into, two or more topics. Additionally, the topics may include, e.g., be broken down into, subtopics. For the purpose of simplicity, use of the term “topic” refers to a topic or its sub-topics. For example, in a curriculum for teaching the subject of geometry, topics included in the curriculum may include “angles,” “solid shapes,” and “volumes of solid shapes.” The topic “volumes of solid shapes” may include the subtopics “volume of a sphere,” “volume of a cube,” and “volume of a cone.”

Progression through a curriculum is based on when the topics included in the curriculum are taught. This may include when instruction of a topic is begun, for how long the topic is taught, and what percentage of emphasis is placed on teaching the topic relative to other topics. When a topic is taught may be indicated by assessments administered by the educator, including when problems assessing the assessment-taker's understanding of the topic are included in the assessments, what percentage of the problems in the respective assessments are related to the topic, and how well the assessment-taker's perform when responding to the problems related to the topic. The assessment-taker's performance on a problem (and optionally knowledge of the degree of difficulty of the problem) may indicate the assessment-taker's level of mastery of the topic(s) related to the problem, and therefore whether the topic has been introduced, partially taught or completely taught.

The tracking of progress may include comparing the progress of the educator to progress of 1) educators who have taught the curriculum or similar material in the past, or 2) peer educators currently teaching the curriculum or similar material. The current educator may compare his progress to that of other educator's that teach (presently or historically) in the same or different schools, districts, states, countries, or various locals.

The EAS assessment is administered, e.g., by a teacher or administrator 112, to one or more assessment-takers 114, such as students or applicants (e.g., for a position, registration, or certification), wherein each assessment-taker is provided with his individual copy of the assessment. The EAS assessment may be digitally created (e.g., by the first workstation 102) and printed (e.g., by the EAS MFD 104), but this is not required. The EAS assessment may be manually created, e.g., typed or handwritten. A digital version of the EAS assessment is created or obtained, such as by scanning the EAS assessment. Furthermore, information is digitally associated with the EAS assessment, such as with the entire assessment or portions of it, such as individual problems, groups of problems or individual potential responses to a problem. This information can be stored, for example, as metadata associated with the EAS assessment or a portion of it, or in a digital EAS assessment template (also referred to as an EAS template) that corresponds to the EAS assessment. Use of the term EAS template herein may include associated metadata. The EAS template may be created, e.g., at the first workstation 102, or obtained from another source, such as a remote source or the EAS database 110. The metadata or EAS template, described further below, associates information with the EAS assessment or portions of it, where the associated information includes, for example, rubrics for grading problems, groups of problems or the EAS assessment as a whole, categories associated with problems posed to the assessment-taker by the EAS assessment, level of difficulty of the respective problems, and/or descriptors associated with potential responses that the assessment-taker may indicate which are responsive to the problems. The assessment-takers 114 take the EAS assessment, including marking the EAS assessment with strokes (e.g., hand drawn strokes using a writing implement, such as a pencil, crayon or pen) that indicate responses to at least one problem provided by the assessment. The term “problem” is applied broadly herein to refer to a prompt for the assessment-takers response or a gauge of the assessment-takers progress with respect to a task. For example, a problem may include a math problem, a reading selection that the assessment-taker reads and is gauged for fluency, a survey question asking for the assessment-takers opinion, etc. In some cases a person other than the assessment-taker marks the EAS assessment, but for the purpose of simplicity, reference to markings by an assessment-taker shall also refer to any other person that is marking the EAS assessment. The EAS assessment may be administered to the assessment-takers in a variety of ways, including in writing, digitally, or in audio. When administered in writing, the assessment-taker may mark the EAS assessment itself or may mark one or more specially provided answer sheets. For simplicity and clarity, the term “marked assessment” includes any marked answer sheets. The marked assessment may include one page (e.g., a paper page) or multiple pages.

The current educator can track or pace his progress through a curriculum that he is teaching by analyzing the categories related to the assessments administered by other educators who are currently teaching or have taught the same or a similar curriculum. Additionally, the current educator can track or pace his progress through a curriculum that he is teaching by analyzing descriptors associated with responses to problems posed by assessments administered by other educators who are currently teaching or have taught the same or a similar curriculum. In order to compare his progress to that of other educators, the current educator may compare categories and descriptors associated with assessments he has administered with categories and descriptors associated with assessments given by the other educators. The other educators may have previously taught the curriculum, may be currently teaching it, or may be teaching a different (e.g., more advanced or related) curriculum that uses skills or information taught in the curriculum, where those skills or information have already been mastered but are now being applied to the different curriculum.

When administered digitally, the EAS assessment is presented to the assessment-taker via a display device of a computing device, such as personal computer or workstation. The assessment-taker can mark the EAS assessment with digital strokes by using a user input device, such as a keyboard. When administered in audio, the assessment-taker may listen to the audio and mark answers on an answer sheet that is included with the EAS assessment. It is also envisioned that the assessment-taker may answer the EAS assessment verbally. Whether the answer is provided by marking a paper using a handwriting instrument, marking a digital file using a computer, marking a digital recording using a voice, the mark is referred to herein as a stroke. Furthermore, each of these forms of administering the EAS assessment may include tracking the timing of the strokes. In each of the scenarios, there are delimiters that specify to a stroke lifting module 320 where or how to find the strokes. These delimiters are provided by the EAS template. Furthermore, there are typically indicators to the assessment-taker as to where or when to mark a stroke.

The marked-up paper EAS assessments are submitted to the EAS MFD 104 to be scanned and then stored. The stored EAS assessments are evaluated by the EAS evaluator 108. The evaluating includes consulting the digital version of the EAS assessment and the EAS template. The evaluated EAS assessments may be validated and annotated by a user of the second workstation 106. The validated EAS assessments are submitted to the EAS evaluator 108 which may generate reports relating to the validated EASs.

The first and second EAS workstations 102 and 106, respectively, are computing devices, such as a personal computer (PC), a handheld processing device (such as a personal digital assistant (PDA)), a mainframe workstation, etc. Each of the computing devices includes a hardware processing device, such as a CPU, microprocessor, ASIC, digital signal processor (DSP), etc.; a memory device, such as RAM, ROM, flash memory, removable memory, etc.; a communication device for enabling communication with other computing devices; a user input device, such as a keyboard, pointing device (e.g., a mouse or thumbwheel), keypad, etc.; and an output device, such as a monitor, speaker, etc.

Each of the first and second workstations 102 and 106 may be in data communication with database 110 and/or with the EAS MFD 104. The first and second workstations 102 and 106 may be configured as a single workstation which is in data communication with the EAS MFD 104, the EAS evaluator 108, and the database 110 and has the functionality of the first and second workstations 102 and 106. The second workstation 106 may further be in data communication with the EAS evaluator 108. The first EAS workstation 102 is operated by a user, also referred to as an assessment author, for creating an EAS template that corresponds to an EAS assessment. The first EAS workstation 102 may also be used to create the EAS assessment. The second EAS workstation 106 is operated by a user for reviewing evaluated assessments for the purpose of validating or annotating the assessments. The users of the first and second workstations 102, 106 may be the same persons, or different persons.

Each of the first and second workstations 102 and 106 may include a user interface (UI), a user input device and/or an output device. The UI interfaces with the user input device and the output device, e.g., by providing a graphical user interface (GUI) for receiving input from and providing output to the user of the respective first or second workstation 102, 104.

The first workstation 102 provides an assessment authoring tool that includes an algorithm executable by the digital processor for generating EAS templates and/or assessments and which interfaces with the UI for allowing a user to create an EAS template. The authoring tool allows the user to interactively create an EAS assessment and/or EAS template. The template describes locations of the physical marked assessment in which to find strokes that correspond to responses by the assessment-taker to the respective problems presented by the EAS assessment, how to interpret the strokes, how to evaluate the strokes, and how to score the individual problems and/or the overall assessment. The EAS template enables the EAS system 100 to automatically evaluate and grade the EAS assessments. Grading the EAS assessments may include generating a score, such as expressed as a percentile (e.g., 92%) or a letter grade (e.g., A−). The EAS template associates information or meta data with the EAS assessment or a portion of it. The author of the EAS template selects which portions of the EAS assessment will have associated information and what the associated information is. Associated information may include rubrics to use for evaluating, names of academic categories that the problem is related to or covers, descriptors associated with potential responses that indicate categories that are well understood or misunderstood, difficulty level of the problem, etc.

The EAS template is not limited to any specific embodiment. The EAS template associates category information with each problem provided in an EAS assessment to describe the subject matter covered by that problem, the difficulty level of the problem, and/or descriptor information with each potential response to the problem to describe a meaning associated with the individual potential responses. Furthermore, the EAS template provides evaluation information that is used for evaluating the individual problems and/or the overall EAS assessment. The category information, descriptor information and/or output from evaluation of the EAS assessment using the evaluation information provided by EAS template can be used for tracking progress through a curriculum.

U.S. patent application Ser. No. 12/640,426 describes one example of an EAS template, wherein the EAS template provides a description of hierarchical data structures and associated attributes, however the current disclosure is not limited to this embodiment of the EAS template. In this example, the attributes include a category attribute that describes the subject matter of each problem or part of a problem, and a descriptor attribute that may include a Descriptor expression that is evaluated based on response indicated by the assessment-taker and returns a descriptor value. Additionally, target value and rubric attributes provide information that is used to evaluate and/or score the responses.

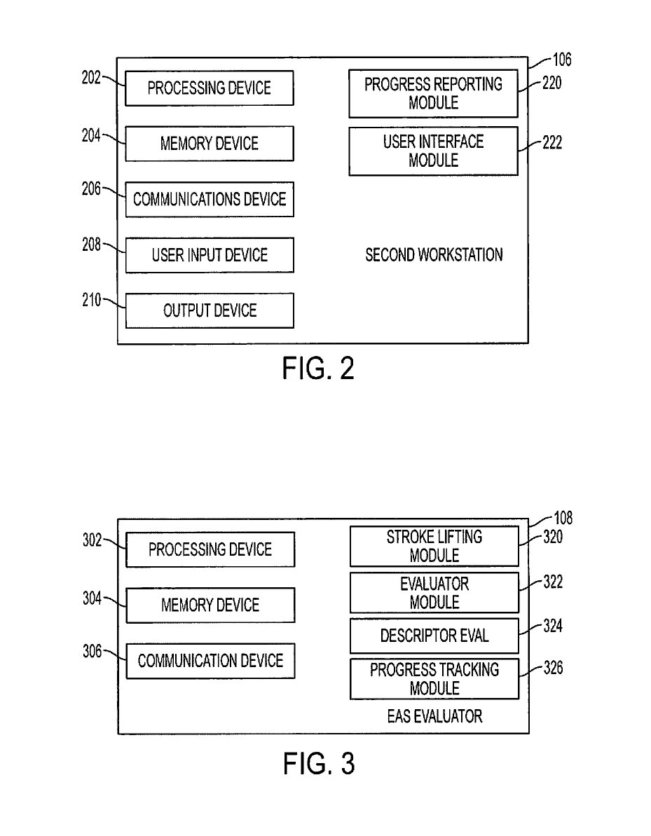

With reference to FIG. 2, second workstation 106 is depicted. As shown, second workstation 106 includes hardware processing device 202, memory device 204, communication device 206, user input device 208, and output device 210. Additionally, the second workstation 106 includes a progress reporting module 220 and a user interface (UI) module 222, each of which is a software module including a series of programmable instructions capable of being executed by the processing device 202. The series of programmable instructions, stored on a computer-readable medium, such as memory device 204, are executed by the processing device 202 for performing the functions disclosed herein and to achieve a technical effect in accordance with the disclosure.

The progress reporting module 220 interacts with the UI module 222 such that the progress reporting module 220 allows the user to interactively request and receive information from the EAS evaluator 108 related to tracking progress through a curriculum, comparing tracked progress to the progress of other educators, plotting average or target progress velocities through a curriculum, determining an optimal progression pace or velocity through a curriculum, and adjusting a planned pace or velocity in response to an event, etc. The second workstation 106 is in data communication with the EAS evaluator 108 and the user may exchange information interactively with the EAS evaluator 108 via the second workstation 106. For example, the user may make his requests to the EAS evaluator 108 via the UI module 222 and progress reporting module 220 of the second workstation 106 and receive the replies to the request at the second workstation 106. The interactive exchange of information may include the EAS evaluator 108 requesting additional information from the second workstation 106 and the second workstation 106 responding with the requested information. These requests and responses may be directed at the user and made by the user of the second workstation 106, respectively, e.g., via a GUI.

The second workstation 106 and the EAS evaluator 108 may interact in a client/server relationship. More specifically, the second workstation 106 may be a web client and the EAS evaluator 108 may be a web server. The interactive communication between the second workstation 106 and the EAS evaluator 108 may be via web pages.

With reference back to FIG. 1, the EAS MFD 104 includes printing, scanning and hardware processing devices that provide printing, scanning, and processing functionality, respectively. The EAS MFD 104 may have access to an EAS database 110. Additionally, the EAS MFD 104 may be provided with a user interface 116, which may include, for example, one or more user input devices (e.g., a keyboard, touchpad, control buttons, touch screen, etc.) and a display device (e.g., an LCD screen, monitor, etc.). The EAS MFD 104 prints a selected EAS assessment, such as upon request from a workstation, such as EAS workstation 102, or upon a user request via the user interface 116. The EAS MFD 104 may receive the selected EAS assessment from the requesting workstation, or may retrieve the EAS assessment, such as by accessing the EAS database 110 or a local storage device provided with the EAS MFD 104 (e.g., a hard drive, RAM, flash memory, a removable storage device inserted into a storage drive (e.g., a CD drive, floppy disk drive, etc.) provided with the EAS MFD 104).

Additionally, the EAS MFD 104 scans an EAS assessment submitted to it and generates an image of the scanned EAS assessment, also referred to herein as the scanned EAS assessment. The scanned EAS assessment is then stored, such as by storing it in the EAS database 110 or in the local storage device provided with the EAS MFD 104. Storing into the EAS database 110 can mean storing the scanned EAS assessment image data directly into the EAS database 110, or storing the image data on a disk drive or other permanent storage media that is accessible to the EAS database 110 and storing the access path to the image data into the database.

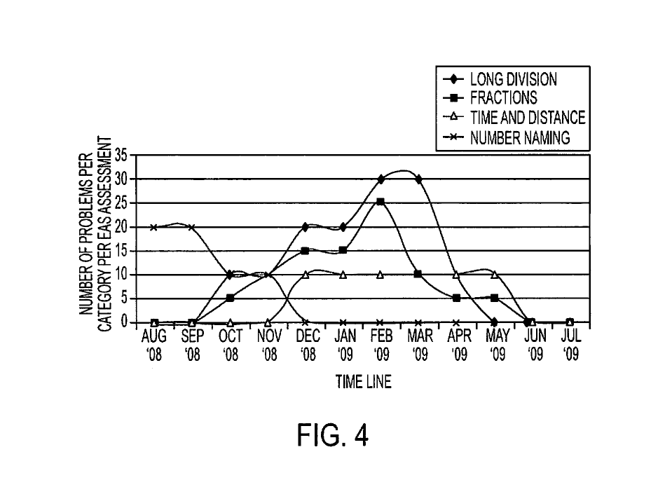

With reference to FIGS. 1 and 3, the EAS evaluator 108 includes at least a hardware processing device 302, such as a CPU, microprocessor, etc.; a memory device 304, such as RAM, ROM, flash memory, removable memory, etc.; and a communication device 306 for enabling communication with other computing devices. The EAS evaluator 108 can receive scanned EAS assessments or retrieve them from storage, such as from the EAS database 110 and evaluate the retrieved EAS assessments. The EAS evaluator 108 can also access and analyze evaluations of EAS assessments. The evaluations may have been performed by the EAS evaluator 108 or by a remote EAS evaluator. In addition, the EAS evaluator 108 can determine progress through a curriculum based on an evaluation of one or more EAS assessments. Progress determinations may be further analyzed by the EAS evaluator 108, including making comparisons between determinations of progress, plotting average or target progress velocities, determining an optimal pace for progression through a curriculum, and adjusting a planned pace or velocity through a curriculum in response to an event.

The EAS evaluator 108 includes the stroke lifting module 320 that recognizes strokes that were made by an assessment-taker 114 on an EAS assessment that is being evaluated, associates a location with the lifted strokes, associates marking attributes with the lifted strokes and generates corresponding location and marking attribute data. The stroke lifting module 320 may use the digital version of the EAS assessment to distinguish between marks that are part of the EAS assessment and strokes that were marked by the assessment-taker. An evaluator module 322 associates the lifted strokes, based on their corresponding locations and marking attribute data, with the EAS assessment's EAS template. The evaluator module 322 uses the association between the lifted strokes and the EAS template, as well as instructions provided by the EAS template, to evaluate the scanned assessment. The EAS evaluator module 322 associates categories with the problems included in the EAS assessment. A descriptor evaluator module 324 associates descriptors with possible answers that may be selected or entered by the assessment-taker in response to the respective problems included in the EAS assessment. Associating the descriptors may include dynamically evaluating Descriptor expressions associated with the EAS template module during evaluation of the scanned assessment and outputting a descriptor.

A progress tracking module 326 includes an algorithm for tracking the educator's progress through a curriculum that he is teaching and/or comparing the tracking results to the progress of educators who have previously taught or are contemporaneously teaching the same or a similar curriculum. The algorithm further can plot an average or target pace or velocity through the curriculum, determine an optimal pace for progression through a curriculum, and adjust a planned pace or velocity through a curriculum in response to an event (e.g., tracked mastery levels based on assessment results, an unexpected emergency or interruption, etc.).

The stroke lifting module 320 processes a digital version (e.g., scanned) of the EAS assessment, recognizes which markings of the scanned assignment are strokes indicating answers provided by the assessment-taker 114 when taking the assessment, and generates data that identifies location and other attributes of the strokes. The generated data may be configured as metadata, for example.

The evaluator module 322 evaluates the scanned assessment. Evaluation of the scanned assessment may include assigning a score (e.g., a percentage correct grade or an academic grade, e.g., A, B+, etc.) to the assessment. The evaluator module 322 processes the recognized strokes, uses the associated location information to determine for each stroke which problem the stroke is response to, and evaluates the stroke, such as to determine when it should be graded as correct or incorrect. Additionally, the evaluator module 322 provides category information related to the problems posed to the assessment-taker by the EAS assessment and descriptor information related to the recognized strokes.

The stroke lifting module 320, the evaluator module 322, the descriptor evaluator module 324, and the progress tracking module 326 are each software modules including a series of programmable instructions capable of being executed by the processing device 302. The series of programmable instructions, stored on a computer-readable medium, such as memory device 304, are executed by the processing device 302 for performing the functions disclosed herein and to achieve a technical effect in accordance with the disclosure. The modules 320, 322, 324 and 326 may be combined are separated into additional modules.

The database 110 includes at least one storage device, such as hard drive or a removable storage device (e.g., a CD-ROM) for storing information created or operated upon by one component of the EAS system 100 that needs to be retrieved or received by another component or the same component at a later time. The database 110 may be a central database, a distributed database, or may include local storage associated with one or more of the components of the EAS system 100. The database 110 or a portion thereof may be remote from the other components of the EAS system 100. The components may share information, such as EAS assessments, scanned EAS assessments, validated EAS assessments, evaluated EAS assessments, progress tracking information, and reports related to evaluations of EAS assessments, by storing information on and retrieving information from database 110. The method of sharing information may be done in a number of ways, such as a first component notifying a second component when a particular file is available for the second component to retrieve or process; the first component sending the file to the second component, or the second component checking the database 110 at regular intervals for files that it needs to retrieve for processing. Examples of information included in the database 110 include digital images of scanned administered EAS assessments, descriptor information and granular data specific to an assessment-taker.

Examples of the structure and/or functionality associated with the EAS MFD 104, the first and second EAS workstations 102, 106, and portions of the EAS evaluator 108, namely the structure of the EAS evaluator 108 and the functionality of the stroke lifting module 320, the evaluator module 322, and the descriptor evaluator module 324 are further described, either to supplement the above description or provide alternative designs, by the Related Applications enumerated above, each of which has been incorporated herein by reference in their entirety.

A detailed description of information provided by the EAS template which is used by the progress tracking module 326 is now provided. As described above, category information is provided in association with each EAS assessment problem. The category information may be associated with the EAS assessment problem in a variety of ways, e.g., it may be provided as a string attribute, an associated field, and/or metadata, Some EAS assessment problems may be divided into two or more parts (e.g., problem #5 may include parts 5A and 5B), and category information may be provided for each part. The category information describes the intent of what the problem is assessing. The category information may not be used during grading, but may be used during analysis of the EAS assessment, e.g., for preparation of reports and/or data mining. The category information may include one or more parts that may be independent or related (e.g., part two may be a subtopic of part one). In the above referenced U.S. patent application Ser. No. 12/640,426, the category information is included in the “strand” and “label” attributes.

The category information typically describes and corresponds to a topic or subtopic that may be listed in a curriculum or syllabus and describes a topic that is being taught. Examples of category information include, “long division,” “fractions,” “time and distance,” “number naming,” “map skills,” “history of the industrial revolution,” “pollination,” “Shakespearean literature,” etc. The category information may include one or more topics, such as a broad topic and a narrow topic included within the broad topic.

The descriptor information provides information that describes a qualitative meaning associated with respective possible responses by the assessment-taker to a problem. For example, the possible responses may include incorrect responses, such as responses that are different than an expected response. The descriptor information provides qualitative information about what type of mistake the assessment-taker made. The descriptor information may be related to a sub-topic within the category that may be helpful in identifying a particular mistake. For example, if the category is long-multiplication, the descriptor information related to the incorrect answers may include one or more of “digit carry problem,” “one's and ten's digit reversal,” “problem lining up digits,” “6-times table problem,” and “operation reversal.” Each potential response by the assessment-taker may indicate an understanding or lack thereof of a different particular topic, and the descriptor information related to each potential response provides an indication of which topics the assessment-taker does or does not understand.

In accordance with the description above, the EAS system 100 gathers information about overall performance on EAS assessments, the content of each problem and each possible answer in the EAS assessments (as described above with respect to the category and descriptor information), and assessment-taker performance per problem. This information is granular, meaning that information is provided about each particular problem, including detailed information about the subject matter being tested by each individual problem and the implications of various correct and incorrect responses to the problem. Additional information may provided about the EAS assessments, such as information relating to the style or method used by the EAS assessment overall and/or individual problems to assess the assessment-takers knowledge and understanding of the subject matter. Furthermore, the EAS system may gather information related to other entities, such as the assessment-takers, a population of assessment-takers, the teachers that taught the material being assessed, teaching methods used, teaching materials used, etc.

This information can be gathered on a granular level, meaning that each piece of information may be searchable, can be analyzed separately from other pieces of information, can be associated with a particular EAS assessment or group of EAS assessments, and/or can be associated with one or more of the other pieces of information. The granular information can be used to analyze, for example, aspects of an EAS assessment or group of EAS assessments, a teaching method, teaching materials, an educator, an individual assessment-taker, and/or an assessment-taker population group, e.g., class, students having special needs, school, school district, etc.

U.S. patent application Ser. Nos. 12/339,979, 12/340,054, and 12/340,116, all to German et al. entitled “SYSTEM AND METHOD FOR RECOMMENDING EDUCATIONAL RESOURCES,” and filed on Dec. 19, 2008, herein incorporated by reference in their entirety, describe a system and method for making educational recommendations by correlating granular assessment data with other information. Granular assessment data indicates student performance for each question in an administered assessment.

The granularity of the data enhances reporting and analysis capabilities. Granular EAS assessment information about particular problems can be associated with information compared to previous EAS assessments taken by the assessment-taker and other EAS assessment-takers, including students currently studying or have previously studied the same or a similar curriculum. The students that the current assessment-taker is compared to may be selected from a particular population, such as: students from the same or a different school, type of school (e.g., public, private or charter), district, demographic or geographic region; students who have studied under the same educator; or students who have a similar special need, learning disability or gift.

The granularity of the data provides the capability for tracking progress through a curriculum. The progress through a curriculum for a student or student population can be tracked by analyzing category information, descriptor information and evaluation information of one or more EAS assessments. Analysis of the category information may include, for example, determining the first occurrence or the frequency of occurrences of one or more selected category in one or more EAS assessments plotted along a time line. The first occurrence of a category may indicate the date of introduction of the subject matter indicated by the category. The term “date” here is used broadly and may refer to a specific date or a date relative to the beginning of teaching the curriculum. The frequency of occurrences of a category may indicate how heavily the topic associated with the category is taught at a particular time. If performance of students that were historically taught the curriculum was acceptable or optimal, the determined frequency may serve as a target frequency for the current educator. This would include analyzing evaluation information as well to determine if performance was acceptable or optimal.

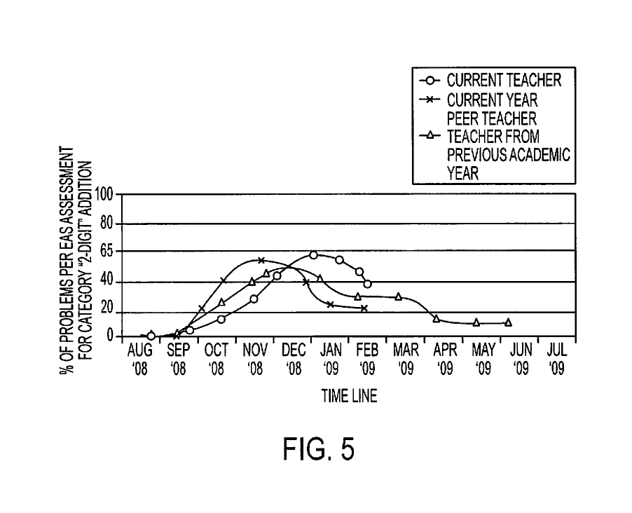

As shown in FIG. 4, the method of the present disclosure may be used to compare the pace at which different topics are being taught. FIG. 4 shows a graph of the frequency of occurrences of problems assessing four different categories in a series of EAS assessments administered to a selected population of students from August 2008-July 2009. A separate plot is shown for each category. The graph shows for each category the absolute number of problems included in the administered EAS assessments that are related to that category, e.g., for assessing the category. Where the plot for a category is shown as flat along the “0” level of the y-axis, the topic has not been assessed. EAS assessments for this student population were not administered during the summer months. The graph shows that “time and distance” was not assessed before November, 2008, that “time and distance” was introduced at the beginning of the year, but tapered off by December, 2008. “Fractions” and “long division” were introduced at the beginning of the year, and the progression in emphasis on theses subjects increased relatively steadily, peaking in February 2009 and March 2009, respectively.

As shown in FIG. 5, the method of the present disclosure may be used to compare the pace at which a selected topic is being taught by different teachers. FIG. 5 shows a graph of the frequency of occurrences of problems related to a particular category, which in the present example is “two-digit addition,” for a respected series of EAS assessments administered by three different teachers from August 2008-July 2009. A separate plot is shown for each teacher. The graph shows for each teacher the percentage of problems include in the administered EAS assessments that are related to two-digit addition, e.g., for assessing the students' mastery of two-digit addition. This percentage shows how many of the problems in the EAS assessments administered at the time shown are assessing two-digit addition relative to the number of problems in those EAS assessments that test other categories. The three teachers include a current teacher (“current teacher”), a teacher who is currently teaching substantially the same curriculum (“current year peer teacher”), and a teacher who has taught substantially the same curriculum the previous academic year (“teacher from previous academic year”).

In February 2009, the current teacher requested the analysis shown in the graph in order to compare his progress teaching the topic “two-digit addition” to the progress of the other teachers. The current teacher may note that the teacher from the previous academic year had emphasized this topic earlier in the year, peaking in November 2008, and has gradually decreased emphasis on this topic, with the emphasis dropping even more in March 2009, Comparing to the current year peer teacher, the current teacher may note that he peaked two weeks later than the current year peer teacher and with a greater emphasis on this topic. He may request an analysis of the performance in this topic by the students taught by the other two teachers to help him determine if he believes that the students learned adequately at each of their paces. If so, he may adjust his pace to better mirror either of those paces. Analysis of performance may be done by analyzing descriptor occurrences or assessment evaluation (e.g., scoring) information.

The method of the present disclosure may include a variety of types of analyses that use (per assessment (or group of assessments)) an absolute number of problems related to a selected topic or a relative number of problems related to the selected topic, e.g., relative to other topics. In general, when an analysis refers to determining or using a number, frequency or quantity of problems related to a topic, the number, frequency or quantity may be absolute or relative.

The descriptor information may indicate problem areas for the students. Analysis of the descriptor information may include, for example, determining the frequency of occurrences of a selected descriptor value or the first occurrence of an absence of a selected descriptor value in one or more EAS assessments. The frequency of occurrences of a particular descriptor may indicate that the topic that the students seem to be having problems with as indicated by the descriptor values has not been fully taught yet. An initial decrease in frequency of the descriptor may indicate when that topic was introduced. A maximum decrease may indicate when the teaching of the topic was substantially accomplished. The first occurrence of an absence of the selected descriptor may indicate that the topic was mastered or was no longer being assessed. If the category information for that time period indicates that the topic was still being assessed, then there is a strong indication of mastery of the topic. The descriptor information may also be graphed or charted against a timeline similarly to the graph shown in FIG. 4 for a visual depiction that is usable to the educator.

Analysis of the evaluation information may include, for example, determining at what point in time the students mastered a particular category that they were being assessed in. This is helpful in determining whether the curriculum pace used achieved acceptable or optimal performance standards, and at what point in time the educational instruction provided for each category was sufficient to achieve mastery. The determination of an optimal pace for progression through the curriculum may include an analysis of historical mastery of the subject matter taught and/or a comparison of historical data that indicates subject mastery to progress velocity through the curriculum. For example, the satisfaction of acceptable and optimal performance standards may be determined by comparing EAS assessment evaluation results for selected problems (e.g., selected based on their associated category) to target results or to results achieved by student peers currently or previously having been taught the curriculum. Acceptable performance standards may be met, for example, by meeting a predetermined minimal level of achievement. Optimal performance standards may be met, for example, by meeting a predetermined higher level of achievement, or meeting the best level of achievement that was achieved by student peers currently learning or who were previously taught the curriculum. e.g., based on an analysis of historical mastery of the subject matter taught and/or a comparison of historical data that indicates subject mastery to progress velocity through the curriculum.

Further, mastery of a category may be used to infer that educational instruction of a category has been covered. This is useful for those cases in which in accordance with a relatively new trend, an educator includes problems in the EAS assessments that relate to all categories which will be covered (but have not been covered yet) and have been covered during the school term. Evaluation of mastery may use analysis of descriptor occurrences or assessment evaluation (e.g., scoring) information for problems related to the category.

Coverage of a category may also be inferred when the number of problems in successive EAS assessments or the ratio of problems in successive EAS assessments directed to the category remains substantially constant. This may indicate that knowledge of the subject matter included in the category is used as a basis for teaching another topic, such as a more advanced topic. For example, once the category of reducing fractions is mastered, fraction reduction may then be used as a tool to solve multiplication (or division) of two fractions.

Tracking progress through the curriculum includes tracking the pace at which each category is taught and may include tracking at what point in time a selected degree of mastery is expected to be achieved. When it has been determined that a curriculum that has been successfully or optimally taught by one or more other educators and the current educator wishes to emulate the pace at which that curriculum was taught, a corresponding target pace may be generated. The target pace may include, for example, a target date for a goal associated with each category included in the curriculum, such as the date at which the category was introduced and/or a selected degree of mastery was achieved. When the other educator includes more than one educator, the target pace may be based on an average pace for those other educators, and each of the target dates may be an average of the dates at which each goal was achieved by the other educators.

The current educator's present pace through the curriculum may be compared to the target pace. The progress tracking module 326 may generate an adjusted target pace that takes into consideration the target pace and the current educator's present pace which the current educator can use to adjust the pace of his progress through the curriculum to most closely emulate the target pace.

Another example of when an adjusted target pace may be generated is when the current educator is following a target pace but an event occurs that interferes with the ability of the current educator to follow the target pace. The current educator may even be an experienced educator who is following a pace that he is accustomed to using, but may be required to make a change to the pace due to the occurrence of an event. Examples of events for which an adjustment may need to made to a target pace include a change in curriculum, a change in the composition of the student body, an interruption (e.g., due to illness or an unexpected emergency), and unacceptable tracked mastery levels based on assessment results.

In operation, with return reference to FIG. 1, at step 0, the assessment author uses the first workstation 102 to author an EAS assessment and an associated EAS template, or to author an EAS template to be associated with an existing EAS assessment. At step 1, a user of the EAS MFD 104 selects an EAS assessment to administer and prints sufficient copies of the EAS assessments. The user of the EAS MFD 104 may retrieve a selected EAS assessment, such as by sending a request from a workstation, e.g., EAS workstation 102 or a personal computer, or operating the user interface 116 to request that the EAS MFD 104 print a selected EAS assessment. Each copy may be individualized by providing information, such as a unique ID, identification (ID code or name) of the assessment-taker that will be administered the EAS assessment, the date, etc. The individualized information may be encoded, such as in an optical code, such as a barcode, associated with an optical zone 604 of the EAS template associated with the EAS assessment. At step 2, the EAS is administered to the assessment-takers who mark the EAS assessment with strokes to indicate their answers. At step 3, a user of the EAS MFD 104 scans the marked assessments. The scanned assessments are stored either locally by the EAS MFD 104 or in the EAS database 110.

At step 4, the scanned assessments are evaluated by the EAS evaluator 108 using the associated EAS template. The evaluation may be a preliminary evaluation. The evaluation may occur automatically or may be requested by the EAS MFD 104, a workstation, or a user interface in data communication with the EAS evaluator 108. The request may indicate the type of evaluation that is requested and further identifies the scanned assessments that should be evaluated. The scanned assessments may be provided to the EAS evaluator 108 by the EAS MFD 104 or the EAS evaluator 108 may be retrieved by the EAS database 110. The associated EAS template may be provided by another processing device, such as the first workstation 102, or the EAS evaluator 108 may be retrieved by the EAS evaluator 108 from the EAS database 110. After evaluation, the evaluated assessments are stored locally by the EAS evaluator and/or are stored by the EAS database 110.

When a scanned assessment is evaluated by the stroke lifting module 320, the evaluator module 322 and the descriptor evaluator module 324, they each access the EAS template and output data that may be used during one of the other modules 320, 322 or 324 during runtime. The stroke lifting module 320 evaluates the scanned assessment by using information provided in the EAS template that tells the stroke lifting module the locations in the scanned assessment from which to retrieve strokes. The stroke lifting module 320 outputs data (e.g., an XML text file) with information about each of the retrieved strokes. The evaluator module 322 uses the EAS template to interpret the output from the stroke lifting module 320, including attributing values to strokes when appropriate, evaluating whether the strokes should be scored as correct or incorrect, and generating scores to be associated with a particular problem, group of problems or the entire EAS assessment. This may be done dynamically as the stroke lifting module 320 performs its evaluation, or it may done after the stroke lifting module 320 has completed its evaluation.

The descriptor evaluator module 324 evaluates the EAS template's Descriptor expressions associated with responses as indicated by the recognized strokes using the output from the evaluator module 322. This may be done dynamically as the evaluator module 322 performs its evaluation or after the evaluator module 322 has completed its evaluation. The descriptor evaluator module 324 outputs data (e.g., an XML text file) that represents the results of its evaluation.

At step 5, a user of the second workstation 106 reviews the evaluated assessments. The user may be the same teacher that administered the EAS assessments or may be another individual, such as with expertise in validating or annotating EAS assessments. The review of the evaluated assessments includes validating the evaluation results, correcting evaluation results, and/or annotating the evaluated assessments. The correcting of the evaluation results may include updating the data output by the evaluator module 322. The evaluated assessments may be provided to the second workstation 106 by the EAS evaluator 108, or the second workstation 106 may retrieve the evaluated assessments from the EAS database 110. The validated and annotated assessments are stored locally by the second workstation 106 and/or are stored by the EAS database 110.

At step 6, the EAS evaluator 108 and/or the descriptor evaluator module 324 generate reports. If during the validation step 5 the user corrected evaluation results, at step 6 the evaluator module 322 may need to perform its evaluation again of all or a part of the validated assessment. This may not be necessary if the evaluation results were corrected during step 5. Generation of the reports by the descriptor evaluator module 324 at step 6 may include reevaluating any portions of the validated assessment that were corrected or updated by the user in step 5. The generated reports may indicate scores for the individual EAS assessments, indicate patterns associated with the individual student that took the EAS assessment, and/or indicate patterns associated with other EAS assessments, including the currently administered EAS assessment or historically administered EAS assessments. The reports may involve data mining and data processing that utilizes the features of the EAS template to cull useful information from the EAS evaluations, as discussed further above. Users may access the reports, request specific types of evaluations and reports, etc., such as via a workstation in data communication with the EAS evaluator 108, such as the second workstation 106.

In addition, at step 5, the user of the second workstation 106 may request progress information or analysis of progress information from the EAS evaluator 108, such as the frequency of the occurrence of a selected category, a selected descriptor, and/or a particular level of performance of problems associated with the selected category. The user may specify the student population for which it is requesting the progress information. For example, the student population may include one or more students (e.g., students having a particular characteristic may be selected from this group or all of the students may be selected) that he is currently teaching, students from a specified population currently being taught by other educators, and/or students from a specified population that were taught the same or a similar curriculum in the past. The user may further specify a comparison of the frequencies of one or more student populations. The comparison may be, for example, of average or mean frequencies, minimum, and/or maximum frequencies.

The user may request a comparison study for comparing the pace of progress through a curriculum of the current educator with the pace of one or more other educators who are currently teaching or previously taught the same or a similar curriculum. Based on the results of the comparison, the user may act to adjust the pace at which he is teaching the curriculum, or he may request that an adjustment be made to a model pace he is currently following for teaching the curriculum.

The user may request an optimization study to determine an optimal pace to progress through a curriculum by analyzing 1) the pace of progress through the curriculum by two or more educators that had previously taught the curriculum to two or more students, based on the category, descriptor and/or evaluation information from EAS assessments administered to the students; and 2) the level of success achieved by the students as measured by EAS assessments administered to the students.

The user can narrow a comparison and/or optimization study to include only educators, students and/or curriculum in the analysis that satisfy selected criteria. For example, the user may narrow the study to include only educators that have similar characteristics to the current educator, such as years of experience teaching the curriculum and/or having a preferred teaching style and/or method similar to the current educator's. The user may further narrow the study to include only students that have similar characteristics to the students of the current educator, such as learning disabilities, previous academic performance overall or in a selected academic area, and/or preferred learning style or method. Finally, the user may narrow the study to include only curricula that have similar characteristics to the current curriculum being (or to be) taught by the current educator, such as curricula using particular educational materials or methods, curricula taught in a particular geographic area, and/or curricula taught in a particular type of school (e.g., public, private, or charter).

The EAS database 110 may store information gathered for many students for many years. The information may describe the category associated with each problem in each EAS assessment administered by each teacher to each of his students. Furthermore, the information may describe the category associated with each possible response to each of the problems, indicating that the category was understood or not yet understood by the assessment-taker. Additionally, information is stored that is associated with each of the students, teachers, teaching methodologies or materials used, etc. This information may indicate characteristics related to the students, teachers, and/or teaching methodologies or materials used, and may indicate how well the categories taught were mastered and at what pace. All of this information can be used for analyzing and/or comparing progress velocity through a curriculum, particularly for students, teachers, or the use of teaching methodologies or materials having selected characteristics.

The user may request that an adjustment be made to the pace at which he is currently teaching a curriculum, such as due to the occurrence of an event or due to the results of a comparison study. The user may specify the nature of the cause for the adjustment or the nature of the adjustment requested. The adjustment may be based on information provided by the user, the results of analysis requested by the user, and/or additional information that may be accessed, e.g., from EAS database 110, such as which categories are required by the school district that the current educator is teaching in.

At step 6, the information requested may be provided by the EAS evaluator 108 to the user of the second workstation 106, e.g., in a displayed or printed report format. The information may be quantitative and/or qualitative and may include graphs and/or charts. The educator requesting the information may use the information to plan or adjust his progress through the curriculum he is teaching or is about to teach.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A processing system for tracking progress through a curriculum having a plurality of topics by analyzing at least one digital assessment, the system comprising:
at least one tangible processor; and
a memory with instructions to be executed by the at least one tangible processor for:
processing the at least one digital assessment, wherein each digital assessment was administered to an assessment-taker and has at least one problem that assesses the assessment-taker's understanding of at least one topic of the plurality of topics; and
determining which topics of the plurality of topics of the curriculum have been taught based at least partially on which topics are associated with the respective problems included in the at least one processed digital assessment.

2. The processing system according to claim 1, wherein respective problems included with each digital assessment have associated data including at least one of:
category information indicating the at least one topic; and
descriptor information associated with respective possible responses to a problem of the respective problems, the descriptor information associated with a possible response indicating the assessment-taker's understanding of a particular topic of the at least one topic, wherein the descriptor information associated with two respective possible responses of the possible responses to a problem indicate the assessment-taker's understanding of different particular topics;
wherein the determining which topics of the plurality of topics have been taught includes processing at least one of the category information and the descriptor information associated with the respective problems included in the at least one processed digital assessment.

3. The processing system according to claim 1, wherein the determining which topics of the plurality of topics have been taught includes processing evaluation results of performance by the assessment-taker associated with respective problems of the plurality of problems included with each assessment of the at least one assessment, wherein the evaluation results indicate a level of mastery of the at least one topic associated with the respective problems.

4. The processing system according to claim 1, wherein the memory further includes instructions to be executed by the tangible processor for determining a pace of progress through a curriculum that has been taught to a group of at least one assessment-taker including:
processing a series of digital assessments administered over time to the group;
calculating a quantity of problems assessing the assessment-takers' understanding of at least one topic of the plurality of topics included in the curriculum for respective digital assessments of the series of digital assessments; and
determining the pace of progress by relating, for respective digital assessments of the series of digital assessments, the quantity calculated for each respective topic of the at least one topic assessed to the time at which the corresponding digital assessment of the series of digital assessments was administered.

5. The processing system according to claim 4, wherein the memory further includes instructions to be executed by the tangible processor for determining an optimal pace for teaching at least one topic of the plurality of topics included in a curriculum including:
accessing evaluation results of performance by a first and second group of assessment-takers that were taught the at least one topic at a first and second pace, respectively, wherein the evaluation results indicate a level of mastery of the at least one topic as assessed by a first and second series of digital assessments administered over time, respectively, to the first and second groups; and
comparing the evaluation results associated with the first and second groups and selecting the pace for progressing through the at least a portion of the curriculum that was used for the group whose evaluation results indicate a higher level of mastery.

6. The processing system according to claim 1, wherein the memory further includes instructions to be executed by the tangible processor for accessing and comparing results of a determination for a first group of at least one assessment-taker of which topics of the plurality of topics of the curriculum have been taught to accessed results of a determination for a second group of at least one assessment-taker of which topics of the plurality of topics of the curriculum have been taught.

7. The processing system according to claim 1, wherein the determining whether a topic of the plurality of topics of the curriculum has been taught to a group of at least one assessment-taker includes determining the frequency of occurrence of problems associated with the topic in a digital assessment administered to the group.

8. The processing system according to claim 3, wherein respective problems included with the at least one digital assessment have associated difficulty information describing a level of difficulty of the associated problem;
wherein the wherein the memory further includes instructions to be executed by the tangible processor for determining how thoroughly the respective topics have been taught, including processing the difficulty information and evaluation results associated with the respective problems included in the at least one processed digital assessment.

9. A computer-readable medium storing a series of programmable instructions configured for execution by at least one hardware processor for tracking progress through a curriculum having a plurality of topics by analyzing at least one digital assessment, comprising the steps of:
processing the at least one digital assessment, wherein each digital assessment was administered to an assessment-taker and has at least one problem that assesses the assessment-taker's understanding of at least one topic of the plurality of topics; and
determining which topics of the plurality of topics of the curriculum have been taught based at least partially on which topics are associated with the respective problems included in the at least one processed digital assessment.

10. The computer-readable medium according to claim 9, wherein respective problems included with each digital assessment have associated data including at least one of:
category information indicating the at least one topic; and
descriptor information associated with respective possible responses to a problem of the respective problems, the descriptor information associated with a possible response indicating the assessment-taker's understanding of a particular topic of the at least one topic, wherein the descriptor information associated with two respective possible responses of the possible responses to a problem indicate the assessment-taker's understanding of different particular topics;
wherein the determining which topics of the plurality of topics have been taught includes processing at least one of the category information and the descriptor information associated with the respective problems included in the at least one processed digital assessment.

11. The computer-readable medium according to claim 9, wherein the determining which topics of the plurality of topics have been taught includes processing evaluation results of performance by the assessment-taker associated with respective problems of the plurality of problems included with each assessment of the at least one assessment, wherein the evaluation results indicate a level of mastery of the at least one topic associated with the respective problems.

12. The computer-readable medium according to claim 9, wherein the steps further include determining a pace of progress through a curriculum that has been taught to a group of at least one assessment-taker including:
processing a series of digital assessments administered over time to the group;
calculating a quantity of problems assessing the assessment-takers' understanding of at least one topic of the plurality of topics included in the curriculum for respective digital assessments of the series of digital assessments; and
determining the pace of progress by relating, for respective digital assessments of the series of digital assessments, the quantity calculated for each respective topic of the at least one topic assessed to the time at which the corresponding digital assessment of the series of digital assessments was administered.

13. The computer-readable medium according to claim 12, wherein the memory further includes instructions to be executed by the tangible processor for determining an optimal pace for teaching at least one topic of the plurality of topics included in a curriculum including:
accessing evaluation results of performance by a first and second group of assessment-takers that were taught the at least one topic at a first and second pace, respectively, wherein the evaluation results indicate a level of mastery of the at least one topic as assessed by a first and second series of digital assessments administered over time, respectively, to the first and second groups; and
comparing the evaluation results associated with the first and second groups and selecting the pace for progressing through the at least a portion of the curriculum that was used for the group whose evaluation results indicate a higher level of mastery.

14. The computer-readable medium according to claim 9, wherein the steps further include accessing and comparing results of a determination for a first group of at least one assessment-taker of which topics of the plurality of topics of the curriculum have been taught to accessed results of a determination for a second group of at least one assessment-taker of which topics of the plurality of topics of the curriculum have been taught.

15. The computer-readable medium according to claim 9, wherein the determining whether a topic of the plurality of topics of the curriculum has been taught to a group of at least one assessment-taker includes determining the frequency of occurrence of problems associated with the topic in a digital assessment administered to the group.

16. An educational assessment system for tracking progress through a curriculum having a plurality of topics by analyzing at least one assessment, the system comprising:
at least one tangible processor;
a memory with instructions to be executed by the at least one tangible processor for:
processing the at least one digital assessment, wherein each digital assessment was administered to an assessment-taker and has at least one problem that assesses the assessment-taker's understanding of at least one topic of the plurality of topics;
processing a digital assessment template which is associated with each digital assessment of the at least one digital assessment and includes associated with each problem at least one of:
category information indicating the at least one topic assessed by the problem; and
descriptor information associated with respective possible responses to the problem, the descriptor information associated with each possible response indicating the assessment-taker's understanding of a particular topic of the at least one topic, wherein the descriptor information associated with two respective possible responses the problem indicate the assessment-taker's understanding of different respective particular topics; and
determining which topics of the plurality of topics of the curriculum have been taught based at least partially on at least one of the category and descriptor information associated with the respective problems included in the at least one processed digital assessment.

17. The processing system according to claim 16, wherein the determining which topics of the plurality of topics have been taught includes processing evaluation results of performance by the assessment-taker associated with respective problems of the plurality of problems included with each assessment of the at least one assessment, wherein the evaluation results indicate a level of mastery of the at least one topic associated with the respective problems.

18. The processing system according to claim 16, wherein the memory further includes instructions to be executed by the tangible processor for determining a pace of progress through a curriculum that has been taught to a group of at least one assessment-taker including:
processing a series of digital assessments administered over time to the group;
calculating a quantity of problems assessing the assessment-takers' understanding of at least one topic of the plurality of topics included in the curriculum for respective digital assessments of the series of digital assessments; and
determining the pace of progress by relating for respective digital assessments of the series of digital assessments the quantity calculated for each respective topic of the at least one topic assessed to the time at which the corresponding digital assessment of the series of digital assessments was administered.

19. The processing system according to claim 18, wherein the memory further includes instructions to be executed by the tangible processor for determining an optimal pace for teaching at least one topic of the plurality of topics included in a curriculum including:
accessing evaluation results of performance by a first and second group of assessment-takers that were taught the at least one topic at a first and second pace, respectively, wherein the evaluation results indicate a level of mastery of the at least one topic as assessed by a first and second series of digital assessments administered over time, respectively, to the first and second groups; and
comparing the evaluation results associated with the first and second groups and selecting the pace for progressing through the at least a portion of the curriculum that was used for the group whose evaluation results indicate a higher level of mastery.

20. The processing system according to claim 16, wherein the memory further includes instructions to be executed by the tangible processor for accessing and comparing results of a determination for a first group of at least one assessment-taker of which topics of the plurality of topics of the curriculum have been taught to accessed results of a determination for a second group of at least one assessment-taker of which topics of the plurality of topics of the curriculum have been taught.
